(19) United States
(12) Patent Application Publication
(10) Pub. No.: US 2007/0013258 A1
(43) Pub. Date: Jan. 18, 2007

(54) Metal-graphite brush

(75) Inventor: Hiroshi Kobayashi, Kariya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/477,455

(22) Filed: Jun. 30, 2006

(30) Foreign Application Priority Data
Jul. 15, 2005 (JP) 2005-206773

(51) Int. Cl. H02K 11/00; H01R 39/38

(52) U.S. Cl. 310/251; 310/238; 310/71

(57) ABSTRACT

A metal-graphite brush for supplying electricity to a coil wound around a core provided at a rotor of a motor includes a sintered material having pores at a surface of the sintered material and in the sintered material. The surface of the sintered material serves as a sliding surface sliding along a sliding surface of a commutator to which the coil is electrically connected for supplying electricity. The metal-graphite brush further includes an emulsion containing a liquid, which vaporizes corresponding to a temperature rise of the sliding surface while the sliding surface is sliding along the sliding surface of the commutator during an operation of the motor, and a solvent, which has a boiling point higher than that of the liquid, and into which the liquid is dispersed as liquid particles, in the pores.

### CROSS REFERENCE TO RELATED APPLICATIONS

This application is based on and claims priority under 35 U.S.C. § 119 to Japanese Patent Application 2005-206773, filed on Jul. 15, 2005, the entire content of which is incorporated herein by reference.

### FIELD OF THE INVENTION

This invention generally relates to a metal-graphite brush. More specifically, this invention pertains to a metal-graphite brush for supplying electricity to a coil wound around a core provided at a rotor of a motor.

### BACKGROUND

For a brush motor, electricity is supplied through a brush slidably contacting with a commutator. A coil wound around a core of a rotor is connected to the commutator. When electricity is supplied to the coil, the rotor starts to rotate by virtue of forces of attraction and repulsion applied from a permanent magnet provided in a housing so as to face the rotor.

In the motor having the configuration described above, when the motor is in operation, the brush slides along the commutator. In such a situation, a surface of the brush, which slides along the commutator, tends to wear. Conventionally, for purposes of restricting the brush from being worn while the motor is in operation, materials used for making a brush have been varied, or the hardness of a brush has been controlled so as to restrict electrical/mechanical wear of the brush, or so as to restrict discharge of sparks occurring at the sliding surface of the brush while the motor is in operation.

A conventional metal-graphite brush, which is applied to a brush motor for a vehicle, is known (for example, refer to JP2001-298913A). Generally, motors applied to a vehicle need to have higher electric current density than other kinds of brushes. For obtaining such higher electric current density, the brush motor described in JP2001-298913A is made by mixing graphite particles and copper particles with use of a binder solvent, and by reduction firing the mixture, and as a result forming a metal-graphite brush.

An example of a conventional method for manufacturing a metal-graphite brush is as follows. As a base material, natural graphite particles are utilized. A dissolved phenol resin, as a binder, is added to the natural graphite particles. Then, the natural graphite particles are kneaded and extruded as a cluster of surface coated graphite particles. Further, electrolytic copper powder is added to the clusters with an amount proportional to the electric current density of the metal-graphite brush. Further, as a solid lubricant, a small amount of molybdenum disulfide powder or tungsten disulfide powder is added to the clusters, in order for obtaining improvement in lubricity between sliding surfaces from such a solid substance. Then, an aggregate are formed into a brush shape by press-formation with electrolytic copper powders and solid lubricant powders and the formed aggregate is sintered in a reducing atmosphere, in which hydrogen gas is contained, and in which nitrogen gas is richly contained, and of which a temperature is from 700° C. to 800° C. In this conventional method, a film of the dissolved phenol resin is formed on a surface of the graphite particles. The dissolved phenol resin is thermally decomposed and carbonized to amorphous carbon at the sintering temperature. The amorphous carbon remains in the brush. The amorphous carbon binds, as a binder, the graphite particles. Then, at the process of sintering, organic substances, which are decomposed from the dissolved phenol resin, turn into carbon dioxide or vapor, and sublimate. At this time, many pores are formed on the surface of the metal-graphite brush and the inside of the metal-graphite brush. Meanwhile, a current density of current flowing in the metal graphite brush made by the method described above is determined from a mixing ratio of the copper powder.

Generally, in a situation where a motor having a metal-graphite brush is applied to a vehicle, the smaller the motor is, the higher the mountability of the motor on the vehicle becomes. Accordingly, if a level of output from the motors is identical, smaller motors have higher value as products. Therefore, a size of the metal-graphite brush is restricted from a point of view of mountability. Accordingly, a brush, of which a sliding area with a commutator is smaller, and of which a length in a diametrical direction is shorter than a rotor, is better. On the other hand, a higher current density is desired for the metal-graphite brush utilized in a motor for a vehicle in order for applying large amount of current to the motor and in order for operating electronic equipment mounted on the vehicle.

However, when the conventional metal-graphite brush is installed to the motor, sparks are discharged from the metal-graphite brush toward the commutator while the metal-graphite brush is in operation. There can be a situation where a temperature at a core of the discharge exceeds 3000° C., this can be recognized from a spectral wavelength of the emitted spark discharge. In such a situation, copper powder configuring the metal-graphite brush sublimate by order of priority, and a part of copper powder is lost from the metal-graphite brush. As a result, the inside of the metal-graphite brush is gradually broken, and therefore wear of the metal-graphite brush occurs.

Further, the higher a volume ratio of copper powder gets, the easier the spark discharge occurs in the metal-graphite brush. Therefore, wear of the metal-graphite brush increases. Because of this, a use of a motor, which has a metal-graphite brush, for a vehicle is sometimes restricted from a point of view of requirement for the motor regarding mountability of the metal-graphite brush and a longevity of the metal-graphite brush against wear.

Further, electric noise occurs in the motor, which has the metal-graphite brush, when sparks discharge from the metal-graphite brush. When such a motor, which has the metal-graphite brush, is utilized in a vehicle, because the motor is installed near other in-vehicle electronic equipment, a condenser or a coil needs to be provided for absorbing the electric noise caused by the spark discharge. In a case where a frequency range of the electric noise signals caused by the spark discharge is wide, plural condensers or coils need to be provided at the motor for absorbing the electric noise. Accordingly, a level of mountability of the motor for the vehicle is further lowered, and excessive cost for countermeasures against the electric noise is required. As described above, the conventional motor, which has the metal-graphite brush, has some drawbacks mainly caused by the sparks, which are discharged from the metal-graphite brush.

A need thus exists for a metal-graphite brush, in which a spark discharge does not occur or is difficult to occur. The present invention has been made in view of the above circumstances and provides such a metal-graphite brush.

### SUMMARY OF THE INVENTION

According to an aspect of the present invention, a metal-graphite brush for supplying electricity to a coil wound around a core provided at a rotor of a motor includes a sintered material having pores at the surface or the inside of the sintered material, the surface of the sintered material serving as a sliding surface sliding along a sliding surface of a commutator to which the coil is electrically connected for supplying electricity, and an emulsion containing a liquid, which vaporizes corresponding to a temperature rise of the sliding surface while the sliding surface is sliding along the sliding surface of the commutator during an operation of the motor, and a solvent, which has a boiling point higher than that of the liquid, and into which the liquid is dispersed as liquid particles, in the pores.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a cross-sectional view illustrating a configuration of a motor, in which a metal-graphite brush according to an embodiment of the present invention is utilized;

FIG. 2 represents a model diagram illustrating a composition of the metal-graphite brush;

FIG. 3 represents a process diagram illustrating a making process of the metal-graphite brush; and

FIG. 4 represents a diagram illustrating a concept of emulsion behavior at a sliding surface of the metal-graphite brush.

### DETAILED DESCRIPTION

According to an embodiment of the present invention, a metal-graphite brush is made of a sintered material which has pores on the surface or the inside of the sintered material. The metal-graphite brush supplies electricity to the coil by sliding along a commutator, to which the coil, which is wound around a core, which is provided at a rotor of a motor, is electrically connected, through sliding surfaces. The metal-graphite brush has an emulsion, which contains a liquid, which vaporizes corresponding to a temperature rise caused by a frictional heat generated when the metal-graphite brush slides along the commutator while the motor is in operation, and a solvent, which has a boiling point higher than that of the liquid, and into which the liquid is dispersed as liquid particles, in the pores. In other words, temperature of the metal-graphite brush rises while the motor is in operation because the frictional heat is generated while the metal-graphite brush slides along the commutator. Based on the temperature rise, temperature of the pores, which are present at the sliding surface of the metal-graphite brush and which are present in the metal-graphite brush, also rises. In particular, the closer the pores are present to the sliding surface, which slides along the commutator, the more the temperature of the pores rises to a larger extent. The liquid, which is dispersed as liquid particles in the solvent, and which is present in the pores, vaporizes before the solvent vaporizes because the liquid has a boiling point lower than that of the solvent. Hereby, the liquid forms a balloon while the liquid vaporizes. Thermal expansion of the balloon formed is restricted by the solvent surrounding the balloon. Accordingly, as the temperature of the balloon rises, the inner pressure of the balloon rises. Then, after the inner pressure of the balloon has achieved atmospheric pressure or higher, the balloon moves from an opening portion of the pores of the metal-graphite brush to the sliding surface of the metal-graphite brush. At this time, the solvent, and components, which are not vaporized, move to the sliding surface with the balloon.

Then, by doing so, liquid substance, such as the solvent, and such as other components which are not vaporized, can be locally interposed between the sliding surface of the metal-graphite brush and the sliding surface of the commutator. Accordingly, a conventional sliding state, in which the sliding surface of the metal-graphite brush slides along the sliding surface of the commutator through a medium including extremely small number of contacting points and almost atmospheric air, can be turned into a new sliding state, in which the sliding surface of the metal-graphite brush slides along the sliding surface of the commutator through a medium including, in addition to extremely small number of contacting points and atmospheric air, the newly formed liquid substance. Because the sliding surface of the metal-graphite brush slides along the sliding surface of the commutator through the medium including the liquid substance, the metal-graphite brush contacts the commutator through the surfaces of the liquid substance. Accordingly, comparing with contact resistance in a situation where the sliding surface of the metal-graphite brush slides along the sliding surface of the commutator through atmospheric air, contact resistance can be lowered. Therefore, generation of spark discharges can be restricted. Further, because a film of the liquid substance is formed on the sliding surfaces, a coefficient of sliding friction between the sliding surfaces can be lowered. Therefore, it is possible to restrict an adhesive wear or a fatigue wear of the graphite, which configures the metal-graphite brush.

As described above, because the emulsion is present in the pores, the liquid, which is present as liquid particles, vaporizes only when the temperature of the sliding surface rises to a predetermined temperature or higher. Then, the balloons, which are present closer to the sliding surface, start to move to the sliding surface by order of priority. Therefore, a limited amount of the liquid substance containing the emulsion, which is present in the pores, can be efficiently utilized at the sliding surface. Comparing with a metal-graphite brush, which has merely an impregnated liquid substance in pores, a period for using the liquid substance can be extended. Further, a temperature, at which the liquid substance seeps out to the sliding surface, can be appropriately set by appropriately selecting, as a liquid which configures liquid particles, a liquid having a different boiling point. Further, the liquid substance can be present at the sliding surface in a wide temperature region by dispersing plural kinds of liquids in the solvent, the liquid that vaporizes at a different temperature.

Further, according to the embodiment of the present invention, the emulsion may contain lubrication oil in the metal-graphite brush. Conventional lubrication oil, such as natural oil, a synthetic oil, or the like, can be applied to the lubrication oil. A kind of lubrication oil is not particularly limited. From a point of view that it is preferable if the lubrication oil has a high thermal decomposition temperature and the lubrication oil is difficult to be oxidized, it is preferable to use a synthetic oil. In other words, if the synthetic oil is not deteriorated by the sliding frictional heat, lubricity of the synthetic oil can be maintained. Then, if such a synthetic oil is utilized, the sliding surface of the metal-graphite brush and the sliding surface of the commutator can be locally filled with the liquid substance containing the synthetic oil. Accordingly, the metal-graphite brush can slide along the commutator while the synthetic oil, which contributes to lubrication action, is interposed between the metal-graphite brush and the commutator. In this case, because the surface of the metal-graphite brush and the surface of the commutator contacts through the synthetic oil, which serves as the medium, the liquid lubrication action can be obtained from the synthetic oil, which serves as the medium. Accordingly, mechanical wear of the metal-graphite brush can be reduced. Further, because the synthetic oil is interposed between the sliding surface of the metal-graphite brush and the sliding surface of the commutator, formation of a water vapor film therebetween, which causes increase in contact resistance therebetween, can be inhibited. Accordingly, loss of electricity can be reduced between the metal-graphite brush and the commutator.

According to the embodiment of the present invention, in the metal-graphite brush, the emulsion can have conductivity. By doing so, electric resistance between the sliding surface of the metal-graphite brush and the sliding surface of the commutator can be smaller than that of atmospheric air as a medium. Therefore, in cooperation with effects from increase in area of the sliding surfaces in contact, contact electric resistance between the metal-graphite brush and the commutator can be lowered. Then, by doing so, intensity of electric field, which is induced at the metal-graphite brush when an electric potential is applied to the metal-graphite brush, can be lowered. Therefore, excitation of π electrons included in the graphite particles becomes difficult. Accordingly, generation of spark discharges can become difficult. As a result, generation of electric wear of the metal-graphite brush, and generation of electric noise from the metal-graphite brush, can be restricted. Further, loss of electricity between the metal-graphite brush and the commutator, caused by a level of contact resistance therebetween, can be small. Accordingly, electric current can efficiently flow in the commutator. Further, Joule heat generated between the sliding surfaces can be substantially reduced. Therefore, oxidation of the commutator at the sliding surface thereof can be restricted. As a result, loss of electricity, which is caused by formation of an oxide film on the commutator at the sliding surface thereof, can be eliminated. Further, destruction of the surface of the commutator, which is caused by a volume expansion because of the oxidation, can be eliminated. As a result, abrasive wear of the metal-graphite brush, which is caused by degradation of flatness of the sliding surfaces because of the destruction of the sliding surface of the commutator, can be eliminated.

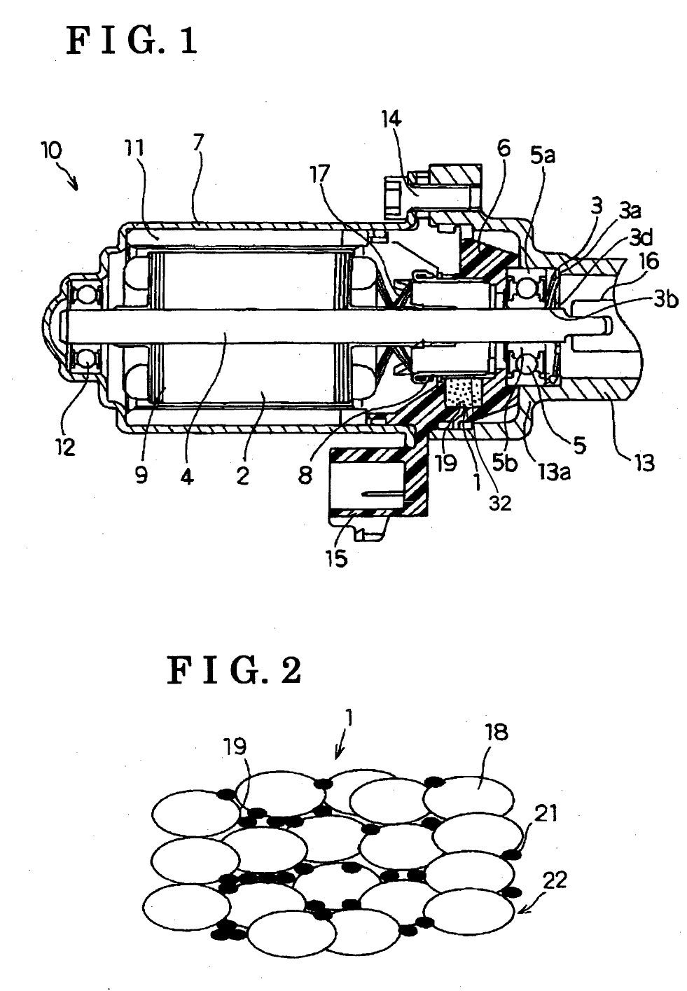

An embodiment of the present invention will be explained with reference to drawing figures. FIG. 1 represents a cross-sectional view illustrating a configuration of a motor 10, in which a metal-graphite brush 1 (simply referred hereinafter as a brush) for supplying electricity to a rotor 2 is utilized. A configuration of the motor 10 will be briefly explained with reference to FIG. 1.

The motor 10, illustrated in FIG. 1, is configured so that the rotor 2 rotates within a housing 7. The rotor 2 is rotatably accommodated in the housing 7 that has a cylindrical shape and that is made of metal. The housing 7, which accommodates the rotor 2, is fixed to a housing 13 by means of a fastening member 14 such as a bolt, and thus integrated into a unit with the housing 13. The rotor 2 is supported by a shaft 4. The shaft 4 has two parallel planes provided at one end of the shaft 4 (right side in FIG. 1). A driven shaft 16 of a driven apparatus is inserted to and connected with the two parallel planes from an axial direction. Thus, rotation of the motor 10 can be externally transmitted from the driven shaft 16.

A core 9 of the rotor 2 is formed by layering plural metal plates in an axial direction. The shaft 4 is inserted through a center of the core by means of press fit and integrated into a unit with the core 9. Thus, the rotor 2 and the shaft 4 rotate together as a unit. The other end of the shaft 4 is inserted into an inner ring of a bearing (a first bearing) 12, pressed and fitted into one end of the housing 7, and thus rotatably supported in the housing 7 by means of the bearing 12. On the other hand, along an inner surface of the cylindrical housing 7, plural arc-shape magnets 11 are attached to the housing 7 by means of an adhesive, or the like, in a peripheral direction.

Further, the housing 13, to which the housing 7 is attached, includes a recessed portion 13a provided at a motor-attachment surface of the housing 13 for attaching the rotor 2. An outer ring 5a of the bearing 5 is attached to the recessed portion 13a by means of press fit. The shaft 4 is supported by the bearing 5. Thus, the shaft 4 for supporting the rotor 2 is rotatably supported by the two bearings 5 and 12 by double support. In this case, the opposite end of the shaft 4, opposite to the position into which the bearing 12 is pressed, is pressed into an inner ring 5b of the bearing 5. The outer ring 5a of the bearing 5 is pressed into the inner side of the recessed portion 13a of the housing 13 so as to be provided along the inner periphery of the recessed portion 13a. In addition, in the housing 13, a spring 3 is provided between the housing 13 of the motor 10 and the bearing 5.

The spring 3 is made from a disc-shaped flat metal plate having strong elasticity (a high spring constant). The spring 3 has a hole 3d, through which the shaft 4 penetrates, at the center thereof. The disc-shaped plate has three slits in a radial direction positioned at distances of 120°. Each slit has an extending slit portion extending clockwise (or counter clockwise) along a peripheral direction of the disc-shaped plate. The disc-shaped plate is bended in an axial direction into a three-dimensional form so as to form biasing portions 3b contiguous with a supporting portion 3a. The supporting portion 3a of the spring 3 make contact with a peripheral stepped portion of the recessed portion 13a so as to engage with the same. The biasing portions 3b of the spring 3 make contact with a side surface of the outer ring 5a of the bearing 5 so as to bias the bearing 5 in an axial direction (left direction in FIG. 1).

On the other hand, a holder 6 is provided near the bearing 5 so as to face the rotor 2. The holder 6 is made of resin, and is provided so as to have the same axis as the housing 7. In addition, the holder 6 includes two brushes 1 (only one of the brushes is illustrated in FIG. 1) for supplying electricity from the commutator 8 to a coil 17, wound around the core 9 provided at the rotor 2, by making contact with the commutator 8. In addition, a connector 15 for supplying electricity from the exterior to the rotor 2 through the brush 1 is provided at the holder 6 so as to form an integral unit with the holder 6. When an external connector (not illustrated) is connected to the connector 15, electricity can be supplied, through the brush 1, to the coil 17 wound around the core 9 of the rotor 2. When electricity is supplied to the coil 17, electromagnetic force of attraction and repulsion is generated between the rotor 2 and the magnets 11, and the rotor 2 starts to rotate.

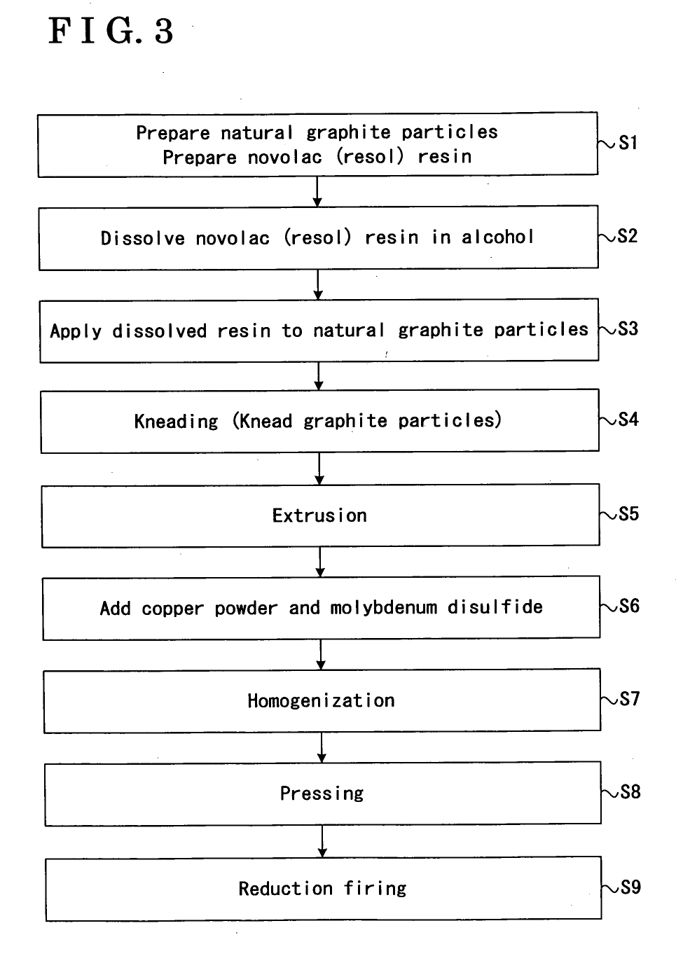

The brush 1, employed in the motor 10 configured and operated as above, will be explained in detail below. According to the embodiment of the present invention, the brush 1 is made of a sintered material 22 having a base of natural graphite particles 18, as illustrated in FIG. 2. The sintered material 22 includes a number of pores 19 on both the surface and the inside of the sintered material 22. Firstly, an example of a manufacturing method of the sintered material 22, which can be made into the brush 1, will be explained with reference to FIG. 3.

For making the brush 1, natural graphite particles (particle diameter: approximately from 5 μm to 150 μm), and novolac-type (or resol-type) phenol resin of granular pellets, 2-3% by weight, as expressed in terms of the graphite particles being 100%, are prepared (S1). Then, the novolac-type (or resol type) phenol resin is dissolved in an alcohol so as to make a phenol resin solution (S2). As the alcoholic solvent, methanol, or the like, can be utilized in this step. Meanwhile, a solvent, into which the novolac-type (or resol type) phenol resin is dissolved, is not limited only to alcohols. For solving the phenol resin, ketones, such as acetone, can also be utilized. Meanwhile, in the step of solving the phenol resin (S2), a thickness of a film of the phenol resin, the film formed on the surface of the graphite particles, varies commensurately with the viscosity of the dissolved phenol resin added to the graphite particles 18. After that, the dissolved resin, in which the phenol resin is dissolved in the alcohol, is sprayed over the natural graphite particles 18 (S3). In the spraying step (S3), the dissolved resin is sprayed so as to form a uniform film of the dissolved resin on the surface of the graphite particles 18.

Next, the graphite particles 18 are kneaded, with the dissolved resin that has been sprayed onto the surface (S4). In this step of kneading, the graphite particles 18 are kneaded by use of a kneading apparatus for a predetermined period of time (for example, from approximately 3 to 5 hours) so as to homogenize the graphite particles 18. After that, the graphite particles 18 that have been homogenized are left in atmospheric air conditions for 30 minutes so as to be dried. Then, the graphite particles 18 which have been dried are formed into a predetermined shape, for example, of which a diameter is approximately 0.5 mm, and of which a length is approximately 2 mm, by means of extrusion (S5).

Next, the graphite clusters (a granulation of graphite particles), which have been formed into the predetermined shape by means of extrusion, are mixed with copper powder, corresponding to the level of electric current that is intended to apply to the brush 1, in order to make the brush 1 so as to have a predetermined current density during the operation of the motor 10 (S6). At the same time, in order to improve a sliding condition with the commutator 8, it is preferable that molybdenum disulfide, which serves as a solid lubricant, also be mixed (S6). By making these processes, the copper powder and the molybdenum disulfide are mixed, and thus homogenized (S7). After that, by means of pressing, or the like, a brush 1 of a desired shape can be press-formed by use of a pressing apparatus (S8). Then, a product obtained by the process is processed by reduction firing, for 2 to 3 hours (S9), in a nitrogen-rich atmosphere, which contains hydrogen, and of which a temperature is from 700° C. to 800° C. (S9). Thus, the phenol resin is processed by the reduction firing. At this time, the phenol resin is turned into carbon monoxide, carbon dioxide, water vapor, and amorphous carbon. The amorphous carbon remains as a solid in a product obtained by the process of the reduction firing. The amorphous carbon, which is generated by the reduction firing, binds the graphite particles one another, and a brush-shaped sintered material 22 is made up. In the sintered material 22, which has been made up as described above, a number of pores 19 are formed, on the surface of the sintered material 22 and the inside of the sintered material 22, between adjacent graphite particles 18, as illustrated in FIG. 2. The pores 19 are formed by gases, which are generated while the phenol resin thermally decomposes.

For impregnating an impregnant 21 into the pores 19 formed at the sintered material 22, which has been made up by the process illustrated in FIG. 3, for example, the metal-graphite brush is put into a container, in which the impregnant 21 is put in, the metal-graphite brush is left in a low pressure state (0.1 atm or lower) for a predetermined time (for example, 30 minutes), and the metal-graphite brush is pulled out from the container. Thus, the inside of the pores 19 of the sintered material 22 of the metal-graphite brush can be filled up with the impregnant 21.

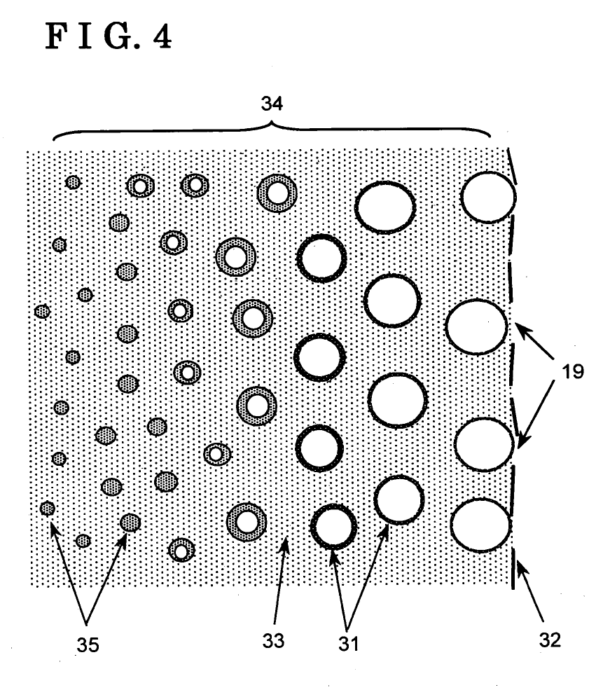

As the impregnant 21, with which the inside of the pores 19 of the brush 1 is impregnated, an emulsion 34 (illustrated in FIG. 4) is utilized. The emulsion 34 contains a liquid 35 (illustrated in FIG. 4) and a solvent 33 (illustrated in FIG. 4) to which the liquid 35 is dissolved as liquid particles. The liquid 35 vaporizes corresponding to a temperature rise caused by a frictional heat generated while the brush 1 slides along the commutator during the operation of the motor. The solvent 33 has a boiling point higher than that of the liquid 35. By doing so, liquid substance, with which the brush 1 is impregnated, can reliably seep out to the sliding surface 32 (illustrated in FIG. 1) of the brush 1 and the sliding surface of the commutator 8. At this time, the liquid substance can seep out by order of priority to the sliding surface 32 of the brush 1 and the sliding surface of the commutator 8.

According to the embodiment of the present invention, an emulsion 34 utilized for the metal-graphite brush 1 is not particularly limited. Various kinds of liquids, which configure liquid particles, and solvents, into which the liquid particles are dispersed, can be selected. For example, as a solvent, a synthetic oil 33 (illustrated in FIG. 4) can be utilized. In a situation where a synthetic oil 33 is utilized as the solvent, it is preferable that a synthetic oil 33 utilized is not thermally decomposed and is not oxidized even at a temperature of the sliding surface 32 of the brush 1 and at a temperature of the sliding surface of the commutator 8. Further, it is preferable that the synthetic oil 33 has, for example, a high viscosity index, good fluidity at low temperatures, ability for retaining an oil film at high temperatures, good thermal stability, good stability against oxidation, and good absorption ability to the surface of the commutator. These lubrication characteristics are preferable for a liquid lubricant. From this point of view, at least one of poly-alpha-olefin, polyalkylene glycol, polyol ester, polyol diester, and polyol triester can be selected as the synthetic oil 33. Such a synthetic oil 33 should preferably be utilized as a lubricant. However, any synthetic oil 33 utilized should not be particularly limited.

Further, various kinds of additive can be added to the synthetic oil 33. For example, to a base oil configuring the synthetic oil 33, following additives can be added:
(1) benzotriazole as an oxidation-inhibiting agent;
(2) benzotriazole as an antirust agent;
(3) polyacrylate as a defoaming agent;
(4) phosphate ester as an extreme pressure agent;
(5) phosphate ester as a wear-resisting agent;
(6) higher alcohol ester as an oiliness agent;
(7) star polymer as an agent for enhancing viscosity index;
(8) polyalkylacrylate as a pour-point depressant; and
(9) polyoxyethylene-type surfactant as a demulsification agent.

From the additives described above, following functions can be given to the synthetic oil 33 respectively.
(1) Function for restricting generation of sludge and lacquer caused by oxidation of the base oil to inhibit chemical absorption of such sludge and lacquer to the surface of the commutator and to inhibit corrosion of the commutator.
(2) Function for inhibiting erosion of the commutator by being chemically absorbed by the surface of the commutator.
(3) Function for breaking a film of bubbles by lowering a surface tension of the bubbles while the base oil foams. Polyacrylate as a defoaming agent is dispersed in the base oil.
(4) Function for restricting adhesive wear by forming a film on the surface of the commutator while the sliding surface is in a critical state.
(5) Function for forming a protection film against adhesion, which has a low melting point, on the surface of the commutator to restrict destruction of the surface of the commutator caused by oxidation.
(6) Function for forming a film which is adhered on the surface of the commutator at low temperatures to reduce a coefficient of sliding friction and to restrict adhesive wear and fatigue wear caused by the slide of the metal-graphite brush along the commutator.
(7) At high temperatures, molecular bond of the star polymer as an agent for enhancing viscosity index is opened and binds with the base oil. As a result of this, reduction of viscosity is restricted, and a film pressure of the base oil can be ensured. Accordingly, adhesive wear and fatigue wear can be inhibited.
(8) Function for restricting precipitation of wax in the base oil at low temperatures to inhibit reduction of fluidity caused by crystalline solidification.
(9) Function for breaking an emulsion made by contamination of water to separate the base oil and water.

A kinetic viscosity of the synthetic oil 33 is not limited to a particular value. However, it is preferable that the kinetic viscosity of the synthetic oil 33 is equal to or lower than 20 cSt at 40° C. It is preferable that the kinetic viscosity of the synthetic oil 33 is equal to or lower than 4 cSt at 100° C. Electric resistance of a gap between the brush 1 and the commutator 8 can be considered as serial resistance including electric resistance formed by a layer of atmospheric air and electric resistance formed by a layer of the synthetic oil 33. When the synthetic oil 33 seeps out into the gap, and when the layer of the synthetic oil 33 is formed in the gap, electric resistance formed by the layer of the atmospheric air becomes lower, and electric resistance formed by the layer of the synthetic oil 33 increases. If a specific resistance of the synthetic oil 33 is lower than a specific resistance of the atmospheric air, electric resistance of the gap becomes lower as time elapses. When a continuous layer of the synthetic oil 33 is formed across the gap, electric resistance of the gap becomes a constant value.

On the other hand, if a viscosity of the synthetic oil 33 becomes too high, the synthetic oil 33 which seeps out into the gap between the brush 1 and the commutator 8 adheres to the sliding surface 32 of the brush 1 and the sliding surface of the commutator 8 with an adhesive force which becomes larger as the viscosity increases. Further, the adhesive force in the synthetic oil 33 also becomes high. Accordingly, a diffusion state of the highly viscous synthetic oil 33, which has seeped out, is more difficult to change than in a situation of the synthetic oil 33 which has a lower viscosity. Therefore, time taken for filling the entire gap with the highly viscous synthetic oil 33 becomes longer than the time in a situation of the synthetic oil 33 which has a lower viscosity. On the other hand, generation of spark discharges becomes more difficult as the electric resistance of the gap becomes lower. Accordingly, if the synthetic oil 33, which has a lower kinetic viscosity, is utilized, a period of time, from the time when the synthetic oil 33 seeps out to the sliding surface 32, to the time when the synthetic oil 33 becomes to a state in which the generation of the spark discharges is difficult, can be shorter.

If spark discharges occur, a part of the spark discharges achieves the commutator 8, a part of the commutator 8 sublimates caused by this, and thus a surface of the commutator 8 is made rough. As a result, the sliding surface of the commutator, the sliding surface sliding along the brush 1, induces abrasive wear at the brush 1. Further, because the sliding surface of the commutator 8 is made rough, a possibility of generation of adhesive wear of the brush 1 to the sliding surface of the commutator 8 increases. Thus, the surface of the commutator 8 is further made rough, which increases a possibility of generation of the spark discharges. The synthetic oil 33, which is present near a portion at which the adhesive wear occurs, is deteriorated by frictional heat. Liquid lubrication action of the synthetic oil 33 deteriorated by the frictional heat becomes low. Thus, electric wear of the brush 1 increases, and a frequency of generation of electric noise becomes high.

In addition, a film of the synthetic oil 33 is formed near a contacting point of the brush 1 with the commutator 8. Electric resistance becomes smaller as a thickness of the film becomes smaller. If the film becomes a monomolecular film, the film has almost zero electric resistance. Further, the film formed on the sliding surfaces is formed, not as points, but as surfaces. Many contacting surfaces are formed on the sliding surfaces. Accordingly, electric resistance between the brush 1 and the commutator 8 can be decreased by large extent. If the viscosity of the synthetic oil 33 is low, a thickness of the film of the synthetic oil 33 near the contacting point can be small. Thus, low viscosity of the synthetic oil 33 can contribute to decrease in the electric resistance. As a result, generation of the spark discharges can be difficult.

As a liquid 35, which is utilized for making the emulsion 34, and which configures liquid particles, a liquid 35, which vaporizes corresponding to a temperature rise caused by a frictional heat generated while the brush 1 slides along the commutator 8 during the operation of the motor, and which has a boiling point lower than a boiling point of the synthetic oil 33, and which can be emulsified with the synthetic oil 33, can be selected. In this case, because the synthetic oil 33 is a non-polar liquid, it is preferable that a polar liquid is selected as a liquid 35, which is dispersed in the synthetic oil 33, and which configures liquid particles. As the polar liquid, for example, water, alcohol, or the like, can be employed.

There are various kinds of alcohols. Each kind of alcohol has a different boiling point from that of others. Accordingly, if a certain kind of alcohol is selected corresponding to a circumstance in which the brush 1 is utilized, the synthetic oil 33 can seep out to the sliding surface 32 at a desired temperature. In other words, for example, if an average temperature of the sliding surface 32 of the brush 1 is approximately 150° C., an alcohol, which has a boiling point approximately at 130° C., can be selected. If an average temperature of the sliding surface 32 rises from 25° C. (exterior air temperature) by 50° C. while the motor 10 is continuously operated, an alcohol, which has a boiling point approximately at 60° C., can be utilized. Further, if the average temperature of the sliding surface 32 has a certain temperature width, and a certain temperature region is formed with a certain frequency, plural kinds of alcohols can be selected corresponding to the certain temperature width respectively, and the plural kinds of alcohols can be mixed at a ratio corresponding to the frequency of the temperature region. Table 1 represents kinds of alcohols, which have a boiling point in a temperature range of 60° C. to 140° C. These kinds of alcohols can be separately utilized corresponding to a temperature at the sliding surface 32 and the frequency of the temperature. For example, in a situation where the temperature of the sliding surface 32 reaches a range within 90° C. to 130° C., if three kinds, in other words, ethanol, 1-propanol, and 1-butanol are selected, at least one kind of alcohol vaporizes in this temperature range. Accordingly, the synthetic oil 33 can seep out to the sliding surface 32. Meanwhile, normally, a temperature of the sliding surface 32 of the brush 1 and the sliding surface of the commutator 8 rises to approximately 160° C. during the operation of the motor. Accordingly, if an alcohol, which has a boiling point in the range described above, is selected, the alcohol can vaporize reliably corresponding to the temperature rise caused by the sliding motion during the operation of the motor.

TABLE 1

| Name of substance | Boiling point |
|---|---|
| methanol | 64.7° C. |
| ethanol | 78.5° C. |
| 1-propanol | 97.4° C. |
| 1-butanol | 117.6° C. |
| isopentyl alcohol | 131.2° C. |

In a situation where the emulsion 34 is made of the synthetic oil 33 and the alcohol described above, if the alcohol is merely mixed with the synthetic oil 33 by a centrifugal separator to emulsify the alcohol in the synthetic oil 33, as time elapses, the alcohol emulsified in the synthetic oil 33 gathers again. For stabilizing the emulsified solution of the alcohol, hydrophobic surfactant, by weight ratio of approximately 2% to the alcohol being 100%, is mixed in the alcohol. By doing so, micro-particles of the alcohol can be stably dispersed in the synthetic oil 33. It is preferable that the surfactant is highly hydrophobic, and the surfactant is not thermally decomposed at 150° C., which is a maximum temperature at the sliding surfaces. Here, a surfactant having special characteristics is not required.

Next, behavior of the emulsion 34, which is obtained as described above, at an opening portion of the pores 19, will be explained with reference to FIG. 4. Because a temperature of the emulsion 34 becomes highest at the opening portion of the pores 19, a pressure of a balloon 31, which is made by the alcohol contained in the emulsion 34, can be at its highest. The balloon 31 comes out to the sliding surface 32. When the balloon 31 comes out to the sliding surface 32 from the opening of the pores 19, because the balloon 31 is present in the synthetic oil 33, the synthetic oil 33 seeps out to the sliding surface 32 with the balloon 31. If the balloon 31 coming out to the sliding surface 32 is smaller than the opening portion of the pores 19, the balloon 31 comes out to the sliding surface 32 with larger amount of the synthetic oil 33.

On the other hand, if the balloon 31 coming out to the sliding surface 32 is larger than the opening portion of the pores 19, the balloon 31 comes out to the sliding surface 32 with smaller amount of the synthetic oil 33. A size of the opening portion of the pores 19 of the sintered material 22 of a practical brush 1 varies within a range from 1 to 30 micron. Accordingly, if the size of the balloon 31 is 30 micron or larger, the amount of the synthetic oil 33, which seeps out, becomes small. Further, if the size of the balloon 31 is controlled to have a predetermined value within a range from 1 micron to 30 micron, the amount of the synthetic oil 33, which seeps out to the sliding surface 32, can be controlled according to the size of the balloon 31. Further, if a kind of alcohol is changed, temperature characteristics of the balloon 31 coming out to the sliding surface 32 can be changed. If these phenomena are combined, in other words, if a size variation of the micro-particles of the alcohol in the emulsion 34 and a variation of a kind of alcohol are combined, the amount of the synthetic oil 33, which seeps out to the sliding surface 32, can be freely designed corresponding to the temperature range and the temperature frequency of the sliding surface 32. Thus, the size of the micro-particles of the alcohol in the emulsion 34 and a kind of alcohol are determined corresponding to the temperature range and the temperature frequency of the sliding surface 32 of the brush 1. Here, the temperature range and the temperature frequency of the sliding surface 32 of the brush 1 are determined according to a usage of the motor 10. For example, the alcohol can be emulsified so that the micro-particles of the alcohol in the emulsion 34 becomes 30 micron or smaller by means of a centrifugal separator with a predetermined rotational speed and a rotating time.

In the meantime, the emulsion 34 can have conductivity. For making the emulsion 34 to have conductivity, electrolyte can be dissolved into the liquid 35, which configures liquid particles, or into the solvent, into which the liquid particles are dispersed, or a conductive liquid material, can be mixed to the emulsion 34. Accordingly, method to make the emulsion 34 to have conductivity is not particularly limited. For a situation where the electrolyte is dissolved, a kind of the electrolyte is not particularly limited. As the electrolyte, a metallic salt, a metallic soap, a surfactant, or the like, may serve as examples. It is preferable that the electrolyte has higher solubility because the electrolyte, which has higher solubility, has higher ionic conductivity. For example, an anionic surfactant, such as sulfuric ester salt, sulfonate, alkyl benzene sulfonate, carboxylate, or the like, and a cationic surfactant, such as ammonium salt, or the like, can be selected. More particularly, as the anionic surfactant, sodium octylsulphate, potassium decanoate, sodium decanoate, lithium (linear) dodecylbenzenesulfonate, or the like, may serve as examples. As the cationic surfactant, decyltrimethylammoniumbromide, or the like, may serve as examples. If such an electrolyte is dissolved, a solution having ionic conductivity of approximately 1 miliSiemens/cm or higher can be obtained.

As the conductive liquid material, for example, an ionic liquid can be utilized. For the ionic liquid, as a cation, pyridinium cation, imidazolium cation, aliphatic amine cation, alicyclic amine cation, or the like, may serve as examples. For an anion, halide ion such as chlorine ion, bromide ion, and iodide ion, or the like, nitrate ion, tetrafluoroborate (BF₄⁻), hexafluorophosphate (PF₆⁻), trifluoromethane sulfonyl (TFSI) [(CF₃SO₂)₂N⁻, (CF₃SO₂)₃C⁻], aluminum chloride [AlCl₄⁻, Al₂Cl₇⁻], or the like, may serve as examples. If the ionic liquid is utilized as the conductive material, because the ionic liquid itself can function also as a lubricant for the sliding surfaces, the ionic liquid can reduce a coefficient of sliding friction between the sliding surface 32 of the brush 1 and the sliding surface of the commutator 8. Accordingly, mechanical wear of the brush 1 can be reduced. For retaining conductivity and lubricity between the sliding surfaces for a long period of time, it is preferable that the ionic liquid is difficult to thermally decompose even at 250° C., and that the ionic liquid has resistance against hydrolysis. For example, an anion including TFSI may serve as an example. Further, it is preferable that the ionic liquid has ionic conductivity of approximately 1 miliSiemens/cm or higher. It is further preferable that the ionic liquid has ionic conductivity of approximately 3 miliSiemens/cm. As the ionic liquid, which has TFSI as an anion, for example, 5 kinds of the ionic liquid, of which chemical formulas are described below, may serve as examples, including:
N,N-diethyl-N-methyl-N-(2-methoxyethyl) ammonium bis (trifluoromethanesulfonyl)imide;
N,N,N-trimethyl-N-propylammonium bis (trifluoromethanesulfonyl)imide;
N-methyl-N-propylpiperidinium bis (trifluoromethanesulfonyl)imide;
1-ethyl-3-methylimidazolium bis (trifluoromethanesulfonyl)imide; and
1-butyl-3-methylimidazolium bis (trifluoromethanesulfonyl)imide.

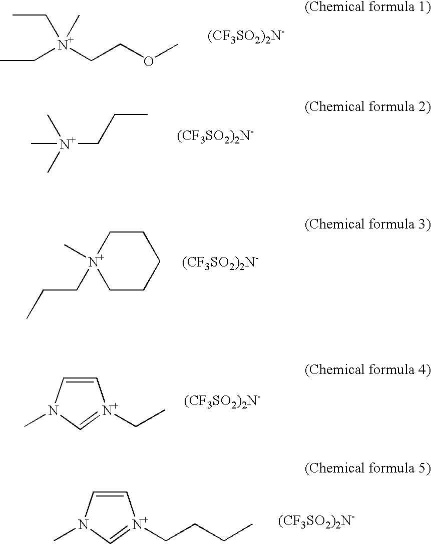

Conductivity of such an ionic liquid at the sliding surfaces is based on a transfer of ions. When the motor 10 is in operation, cations and anions transfer by electric potential applied between the brush 1 and the commutator 8. Then, because a sliding state is always changing, arrangement of cations and anions at the sliding surface 32 of the brush 1 and at the sliding surface of the commutator 8 changes with time. Further, when the sliding surface 32 of the brush 1 does not slide along the sliding surface of the commutator 8, or when the motor is not in operation, the arrangement is released. Thus, because the sliding state of the brush 1 with the commutator 8 changes, arrangement of the cations and anions at the sliding surfaces changes with time. Accordingly, ionic conductivity based on transfer of the cations and anions can be retained. Further, on the basis of release of the arrangement and rearrangement of ions, ionic conductivity based on the transfer of the ions can be maintained.

In the meantime, the ionic liquid can be directly dispersed in the synthetic oil 33 as liquid particles. It is also possible that the ionic liquid is dissolved in, for example, an alcohol, which vaporizes at a predetermined temperature, and after that, the alcohol containing the ionic liquid is dispersed in the synthetic oil 33. It is also possible that the ionic liquid is dissolved in, for example, at least one of alcohols, which have various boiling points, and after that, the alcohol, which contains the ionic liquid, and other alcohols are dispersed in the synthetic oil 33. By doing so, the synthetic oil 33 and the ionic liquid can seep out to the sliding surface 32 corresponding to the boiling points of the alcohols. Further, in a situation where an electrolyte is utilized, if the electrolyte is dissolved in an alcohol, or the like, similar effects can be obtained. In particular, because ions are generated when the electrolyte mentioned above is dissolved in the alcohol, and because the electrolyte has high solubility in the alcohol, ion conductivity of the alcohol solution can be high. Accordingly, the electrolytes mentioned above are preferable.

In the meantime, the emulsion 34 described above can be further dissolved in another solvent as liquid particles. By doing so, a double-structured emulsion, which has double emulsion structure, can be made. It is preferable that the solvent, into which the emulsion 34 described above is dissolved as liquid particles, is selected so that the solvent has a boiling point higher than that of the synthetic oil 33, and so that the solvent can be emulsified with the synthetic oil 33, and so that the solvent is not thermally decomposed even at a maximum temperature of the sliding surface 32 of the brush 1, for example, at 150° C. From this point of view, and from a point of view that liquid particles of the emulsion 34 are formed so that the non-polar synthetic oil 33 surrounds the polar liquid, for example, hydrophilic fatty acid ester, which is a polar solvent, and which has a resistance against thermal decomposition, can be utilized. Such an emulsion 34 can have ionic conductivity if the ionic liquid or the alcohol solution, in which the electrolyte is dissolved, or the like, is mixed with the synthetic oil 33. In this case, the conductive liquid material is emulsified with the synthetic oil 33. Thus, if the emulsified synthetic oil 33 is utilized as the liquid, which configures liquid particles, to make the double-structured emulsion, in which the liquid particles are dispersed in another solvent, the liquid as liquid particles can have new plural characteristics, such as lubricity, or the like.

For making the double-structured emulsion, the emulsion 34, which is made up by preliminary dispersing the alcohol solution in the synthetic oil 33 by the method described above, hydrophilic fatty acid ester, and a hydrophilic surfactant in an amount approximately 2% by weight in terms of the emulsion 34 of the synthetic oil 33 being 100%, are homogenized by means of a centrifugal separator. By doing so, micro-particles of the emulsion 34 of the synthetic oil 33 can be stably dispersed in the fatty acid ester. A rotational speed and a rotating time, for homogenizing the solution, can be determined so that a size of the micro-particles of the synthetic oil 33 becomes approximately 5 times to 10 times that of a size of the alcohol.

Examples will be explained below. In those examples, the metal-graphite brush 1 was impregnated with the impregnant 21 in the pores 19 formed at the surface thereof and the inside thereof. The impregnation was conducted under a low-pressure condition. The brush 1 was installed to the motor 10. Then, action of the motor 10 in operation was tested. Meanwhile, the test was conducted with use of the metal-graphite brush 1, which had a dimension of 4.5 mm×9.0 mm. Load applied to the commutator 8 from the brush 1 was set to 78.5 kPa. Rotational speed (periphery) of the motor 10 was set to 3.6 m/s. A level of current flowing between the brush 1 and the commutator 8 was set to 10A. Under the conditions described above, the motor 10 was rotated. The motor 10 was continuously rotated under a condition that an atmospheric temperature was 100° C.

A first example will be explained. In the first example, as the ionic liquid, N,N-diethyl-N-methyl-N-(2-methoxyethyl) ammonium bis (trifluoromethanesulfonyl)imide was utilized. The ionic liquid can be dissolved in a various solvent, such as chloroform, methanol, ethanol, acetone, tetrahydrofuran, ethyl acetate, dimethylformamide, 1-propanol, 1-butanol, and isopentyl alcohol, at a volume ratio of 1:1. Further, ionic conductivity of the ionic liquid is approximately 3×10⁻³ Siemens/cm. In the first example, 0.2 by volume of methanol and 0.4 by volume of 1-butanol were mixed with the ionic liquid being 1 by volume. Thus, alcohol solution of the ionic liquid was made. Then, as the synthetic oil 33, into which the alcohol solution of the ionic liquid was dispersed, poly-alpha-olefin was utilized. Thermal decomposition ratio of the poly-alpha-olefin at 250° C. is 2 to 3%. Hydrolysis ratio of the poly-alpha-olefin is 2 to 3%. Kinetic viscosity of the poly-alpha-olefin is 4 cSt at 100° C., 17 cSt at 40° C., and 2500 cSt at −40° C. Pour point of the poly-alpha-olefin is −70° C. Viscosity index of the poly-alpha-olefin is 122. The alcohol solution of the ionic liquid, 0.4 by volume, was mixed with the poly-alpha-olefin, one by volume. Then, the mixture was homogenized by using a centrifugal separator. Thus, the alcohol solution of the ionic liquid was emulsified so that the alcohol solution of the ionic liquid becomes 1 μm or smaller. Next, the emulsion 34 described above was put into a container. Then, the metal-graphite brush 1 was put into the container so that the metal-graphite brush 1 was impregnated with the emulsion 34. After that, a pressure in the container was lowered to 0.1 atm by means of a vacuum pump. The pressure in the container was maintained at 0.1 atm for thirty minutes. Thus, the brush 1, which was impregnated with the emulsion 34, which serves as the impregnant 21, in the porosities 19 of the brush 1, was obtained. As a result of a test with use of the metal-graphite brush 1, it was found that the brush 1 could have a practical performance after the brush 1 had been continuously operated for 3000 hours.

Next, a second and a third example will be explained. In the second example, methanol was emulsified with the poly-alpha-olefin, and the emulsion 34 was dispersed in a fatty acid ester. The resulting product was utilized as the impregnant 21. In the third example, potassium decanoate was dissolved in the methanol in the second example at a solubility limit at 25° C. As a result, as described in Table 2, in the second example, speed of increase in degree of wear of the brush 1 did not change by large amounts during a continuous 1000 hours operation of the motor 10. However, the degree of wear of the brush 1 increased before the motor 10 completed a continuous 2000 hours operation, and the brush holder broke. From this result, it was found that the motor 10 according to the second example could continuously operate for 1000 hours at minimum under this load condition. Accordingly, the brush 1 according to the second example can be applied to various kinds of in-vehicle motors 10. In the third example, large effects from conductivity between the sliding surfaces could be obtained. The brush 1 could have practical performance after continuous operation for 3000 hours under this load condition. Further, it was found that the degree of wear of the brush 1 could be reduced from that of a conventional brush in every example.

TABLE 2

| | Example 2 | Example 3 | Conventional example |
|---|---|---|---|
| The degree of | 0.2 mm | 0.1 mm | 0.3 mm |
| wear after 100 | | | |
| hours | | | |
| The degree of | 0.3 mm | 0.2 mm | 0.5 mm |
| wear after 200 | | | |
| hours | | | |
| The degree of | 0.7 mm | 0.4 mm | 2.5 mm |
| wear after 500 | | | |
| hours | | | |
| The degree of | 1.5 mm | 0.8 mm | — |
| wear after 1000 | | | |
| hours | | | |
| The degree of | — | 1.5 mm | — |
| wear after 2000 | | | |
| hours | | | |
| The degree of | — | 2.5 mm | — |
| wear after 3000 | | | |
| hours | | | |

As described above, according to the embodiment of the present invention, entire inner pores 19 of the metal-graphite brush are impregnated with the impregnant 21, which contains the synthetic oil 33 and the conductive liquid. Accordingly, in addition to liquid lubrication function, restriction of spark discharges at the time of sliding can be obtained. This synergetic effect can reduce the degree of wear of the metal-graphite brush 1. Further, because contact resistance between the brush 1 and the commutator 8 can be reduced, output of the motor 10 can increase.

According to a first aspect of the present invention, a metal-graphite brush for supplying electricity to a coil wound around a core provided at a rotor of a motor includes a sintered material having pores at a surface of the sintered material and in the sintered material, the surface of the sintered material serving as a sliding surface sliding along a sliding surface of a commutator to which the coil is electrically connected for supplying electricity, and an emulsion containing a liquid, which vaporizes corresponding to a temperature rise of the sliding surface caused by frictional heat generated while the sliding surface is sliding along the sliding surface of the commutator during an operation of the motor, and a solvent, which has a boiling point higher than that of the liquid, and into which the liquid is dispersed as liquid particles, in the pores.

According to the aspect of the present invention, a temperature of the metal-graphite brush rises while the motor is in operation caused by a sliding friction between the metal-graphite brush and the commutator. Then, the liquid dispersed in the solvent in the pores vaporizes before the solvent vaporizes. Accordingly, the liquid forms a balloon. The balloon moves to the sliding surface, which is atmospheric pressure, with the solvent, and with other components which do not vaporize, after an inner pressure of the balloon becomes atmospheric pressure or higher. Then, the sliding surface of the metal-graphite brush may come in contact with the sliding surface of the commutator through liquid substance, which serves as a medium, because the liquid substance, such as the solvent and the other components, which do not vaporize, can be locally interposed between the sliding surfaces. Accordingly, the metal-graphite brush contacts the commutator through the surfaces. Therefore, contact resistance between the metal-graphite brush and the commutator can be reduced. As a result, generation of spark discharges can be restricted. Further, because a film of the liquid substance is formed on the sliding surfaces, frictional coefficient between the sliding surfaces can be reduced. Accordingly, adhesive wear and fatigue wear of graphite, which configures the metal-graphite brush, can be restricted.

Thus, because the emulsion is present in the pores of the metal-graphite brush, the liquid vaporizes only when the temperature of the sliding surface reaches a predetermined or higher temperature. At this time, balloons, closer to the sliding surface, move to the sliding surface by order of priority. Because the liquid, which is present in the pores, moves by itself, a limited amount of the liquid substance, which contains the emulsion, and which is present in the pores of the metal-graphite brush, can be efficiently utilized between the sliding surfaces. Accordingly, in comparison with a brush, which is merely impregnated with the liquid substance in the pores of the brush, a period for using the liquid substance can be extended. Further, if a liquid having a different boiling point is selected, temperature at which the liquid substance seeps out to the sliding surface can be appropriately set. Further, if plural kinds of liquids, which vaporize at various temperatures, are dispersed in the solvent, the liquid substances can be present at the sliding surface within a wide temperature range.

According to a second aspect of the present invention, the emulsion contains a synthetic oil.

According to the aspect of the present invention, because the metal-graphite brush contacts with the commutator through the liquid substance, which contains the synthetic oil as a medium, liquid lubrication action can be obtained from the synthetic oil as the medium. Accordingly, mechanical wear of the metal-graphite brush can be reduced. Further, because the synthetic oil is interposed between the sliding surfaces, formation of a water vapor film on the sliding surfaces, which causes increase in contact resistance between the sliding surfaces, can be inhibited. Accordingly, electric loss between the metal-graphite brush and the commutator can be reduced.

According to a third aspect of the present invention, the synthetic oil includes at least one of poly-alpha-olefin, polyalkylene glycol, polyol ester, polyol diester, and polyol triester.

According to the aspect of the present invention, the synthetic oil has lubrication characteristics, such as high viscosity index, good fluidity at low temperatures, good ability for retaining an oil film at high temperatures, preferable thermal stability, good stability against oxidation, and good absorption ability to a surface of the commutator, or the like, which are preferable characteristics for liquid lubricants. Accordingly, the synthetic oil can be applied as a good lubricant for the sliding surfaces.

According to a fourth aspect of the present invention, the emulsion has conductivity.

According to the aspect of the present invention, electric resistance between the sliding surfaces can be smaller than that of atmospheric air as a medium. Accordingly, contact (electric) resistance between the metal-graphite brush and the commutator can be reduced. Therefore, intensity of electric field, which is induced at the metal-graphite brush when electric potential is applied to the metal-graphite brush, can be reduced. As a result, excitation of π electrons in the graphite particles becomes difficult, and generation of spark discharges can be difficult. Accordingly, electric wear of the metal-graphite brush and generation of electric noise from the metal-graphite brush can be restricted. Further, electric loss, which is on the basis of contact electric resistance between the metal-graphite brush and the commutator, can be reduced. Accordingly, electric current can flow efficiently in the commutator. Further, Joule heat generated by the sliding surfaces can be reduced by a large amount. Accordingly, oxidation phenomena of the sliding surface of the commutator can be restricted. Therefore, electric loss, which is caused by formation of an oxide film on the commutator, can be eliminated. At the same time, possibility of destruction of the commutator caused by volume expansion induced by oxidation of the surface of the commutator can be lowered. As a result, abrasive wear of the metal-graphite brush, which is caused by degradation of planarity of the sliding surface of the commutator, the degradation which is induced by the destruction of the sliding surface of the commutator, can be eliminated.

According to a fifth aspect of the present invention, the emulsion contains at least one of a metallic salt, a metallic soap, a surfactant, and an ionic liquid.

According to the aspect of the present invention, the emulsion can have conductivity.

According to a sixth aspect of the present invention, the liquid is an alcohol which has a boiling point within a range from 60° C. to 140° C.

According to the aspect of the present invention, because a boiling point of alcohol is lower than a maximum temperature of the sliding surface of the metal-graphite brush and the sliding surface of the commutator during the operation of the motor, the liquid close to the sliding surface can reliably vaporize corresponding to the temperature rise caused by frictional heat of sliding during the operation of the motor.

According to a seventh aspect of the present invention, the alcohol vaporizes and forms a balloon during the operation of the motor, and the balloon moves to the sliding surface of the metal-graphite brush when an inner pressure of the balloon rises.

According to the aspect of the present invention, only when a temperature of the sliding surface of the metal-graphite brush becomes a predetermined temperature or higher, the alcohol vaporizes, and the balloon close to the sliding surface of the metal-graphite brush moves to the sliding surface of the metal-graphite brush by order of priority. Accordingly, the liquid substance, which contains a limited amount of the emulsion in the pores, can be efficiently utilized between the sliding surfaces. In comparison with a brush, which is merely impregnated with the liquid substance in the pores, a period for using the liquid substance can be extended.

A motor having a metal-graphite brush according to the embodiment of the present invention can be applied for a vehicle use, such as a motor for actuating a water pump for purposes of cooling an engine of a vehicle, a motor for actuating a cooling fan, and a motor for actuating an oil pump of an engine. However, the present invention is not limited thereto, and can be applied for a variety of applications.

The principles, preferred embodiment and mode of operation of the present invention have been described in the foregoing specification. However, the invention that is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents that fall within the spirit and scope of the present invention as defined in the claims, be embraced thereby.

1. A metal-graphite brush for supplying electricity to a coil wound around a core provided at a rotor of a motor, comprising:
a sintered material having pores at a surface of the sintered material and in the sintered material, the surface of the sintered material serving as a sliding surface sliding along a sliding surface of a commutator to which the coil is electrically connected for supplying electricity; and
an emulsion containing a liquid, which vaporizes corresponding to a temperature rise of the sliding surface while the sliding surface is sliding along the sliding surface of the commutator during an operation of the motor, and a solvent, which has a boiling point higher than that of the liquid, and into which the liquid is dispersed as liquid particles, in the pores.

2. The metal-graphite brush according to claim 1, wherein
the emulsion contains a synthetic oil.

3. The metal-graphite brush according to claim 2, wherein
the synthetic oil includes at least one of poly-alpha-olefin, polyalkylene glycol, polyol ester, polyol diester, and polyol triester.

4. The metal-graphite brush according to claim 1, wherein
the emulsion has conductivity.

5. The metal-graphite brush according to claim 2, wherein
the emulsion has conductivity.

6. The metal-graphite brush according to claim 3, wherein
the emulsion has conductivity.

7. The metal-graphite brush according to claim 4, wherein
the emulsion contains at least one of a metallic salt, a metallic soap, a surfactant, and an ionic liquid.

8. The metal-graphite brush according to claim 5, wherein
the emulsion contains at least one of a metallic salt, a metallic soap, a surfactant, and an ionic liquid.

9. The metal-graphite brush according to claim 6, wherein
the emulsion contains at least one of a metallic salt, a metallic soap, a surfactant, and an ionic liquid.

10. The metal-graphite brush according to claim 1, wherein
the liquid is an alcohol which has a boiling point within a range from 60° C. to 140° C.

11. The metal-graphite brush according to claim 10, wherein the alcohol vaporizes and forms a balloon during the operation of the motor, and the balloon moves to the sliding surface when an inner pressure of the balloon rises.
